(19) United States
(12) Patent Application Publication
(10) Pub. No.: US 2005/0024500 A1
(43) Pub. Date: Feb. 3, 2005

(54) Camera device, electronic device, and image processing method for same

(75) Inventor: Yasuhiro Katayama, Yokohama (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 10/902,401

(22) Filed: Jul. 29, 2004

(30) Foreign Application Priority Data
Jul. 31, 2003 (JP) 2003-204906

(51) Int. Cl. H04N 5/225

(52) U.S. Cl. 348/207.99

(57) ABSTRACT

A camera device, able to shorten the time required for image adjustment of a camera, having a controller receiving a detection signal of a rotational position detector, making an automatic gain control circuit and an image acquisition control circuit operate to adjust the gain and adjust the image acquisition speed by a control signal when an imaging unit is positioned at (facing) a first opening, and stopping the gain adjustment operation of the automatic gain control circuit and the image acquisition speed adjustment operation of the image acquisition control circuit by a control signal when the imaging unit is not positioned at (facing) a first opening.

### BRIEF DESCRIPTION OF THE INVENTION

1. Field of the Invention

The present invention relates to a camera device with a camera unit arranged rotatably in the housing of a mobile phone, a personal digital assistant (PDA), a digital camera, a laptop computer, or other electronic device, an electronic device, and an image processing method for the same.

2. Description of the Related Art

Demand for mobile phones, PDAs, digital cameras, laptop computers, and other portable electronic devices mounting camera units, that is, mobile terminals, has been rising.

As such a type of electronic device, for example, a mobile phone or another mobile terminal provided with a detachable adapter for transmitting and receiving voice signals, images, etc. by an information communication function and an imaging unit rotatably supported in the adapter and able to change the direction of imaging in accordance with the direction of rotation has been proposed (for example, see Japanese Unexamined Patent Publication (Kokai) No. 11-164273).

Summarizing the problems to be solved by the invention, in such a device, the shooting direction can be freely changed, so there is the advantage of a superior shooting directionality enabling an object to be freely shot while viewing an LCD or other display. At the time of use, however, complicated work of attaching the adapter to the electronic device and detaching it becomes necessary. Further, the adapter provided with the camera unit has to be carried separate from the electronic device. This results in problems in terms of user friendliness.

Therefore, in recent years, mobile phones, PDAs, digital cameras, laptop computers, and other mobile terminals with built-in rotatable camera units have been marketed. As a mobile terminal carrying a camera unit, for example, there is one provided with a lower housing, an upper housing, a hinge section, an imaging part, and a linkage mechanism, wherein the imaging part is provided rotatably at the end of the hinge section and can be freely adjusted in angle of rotation by a turning action of the upper housing and a turning action by a finger.

However, a camera functions to adjust the image when acquiring a captured image. For example, it operates an automatic gain control (AGC) section of the camera in accordance with the surrounding brightness to raise the gain when dark (raise the amplification rate of the image signal from the camera sensor unit) and conversely lower the gain when bright (lower the amplification rate of the image signal from the camera sensor unit).

As explained above, the camera unit is made rotatable. The imaging unit including the lens of the camera unit is designed to pass through the inside of the housing when arranged in the housing. In this case, since light does not enter the housing, it is a dark location. Therefore, the AGC function of the camera operates to raise the gain. Further, after the imaging unit of the camera unit passes through the housing and faces outside the housing and is in a bright location, the AGC function operates to raise the gain again.

Under these conditions, there is the disadvantage that convergence times are required until lowering and raising the gain of the AGC and again lowering the gain of the AGC and therefore the overall convergence time at the change of the gain of the AGC becomes long.

Further, as image adjustment, in addition, sometimes the camera functions to change the exposure time for adjusting the exposure. Specifically, the camera changes the image acquisition speed (frame rate) in accordance with the surrounding brightness to reduce the speed and thereby increase the light acquisition time of the when it is dark and conversely to increase the speed and thereby shorten the light acquisition time when it is bright.

In the above way, when making the camera unit rotatable and arranging it inside the housing, the imaging unit including the lens of the camera unit passes through the inside of the housing. In this case, since light does not enter the housing, it is a dark location. Therefore, the image acquisition speed in the camera function becomes slower. Further, after the imaging unit of the camera unit passes through the inside of the housing and faces outside the housing and is in a bright location, the image acquisition speed is again increased.

Under these conditions, there is the disadvantage that the image acquisition speed becomes slower once. Time is required until the image acquisition speed becomes faster again. Overall, the convergence time in changes of the image acquisition speed is long.

### SUMMARY OF THE INVENTION

An object of the present invention is to provide a camera device able to shorten the time required for image adjustment of a camera.

According to a first aspect of the present invention, there is provided a camera device, comprising a housing at which at least one opening is formed, a camera unit arranged rotatably inside the housing and arranged so that an imaging unit for capturing an image can be positioned at an opening along with rotation, an image processor for performing a predetermined adjustment operation on the captured image in accordance with a surrounding brightness, a position detector for detecting a rotational position of the camera, and a controller for making the image processor operate to perform a predetermined adjustment operation when the detection result of the position detector is that the imaging unit is positioned at the opening, and for making the image processor stop the predetermined adjustment operation when the detection result is that the imaging unit is not positioned at the opening.

Preferably, the image processor includes an automatic gain control section operating in accordance with a control signal to adjust a gain for an image signal from the imaging unit in accordance with a surrounding brightness of the imaging unit and the controller makes the automatic gain control section operate to adjust the gain by the control signal when the detection result of the position detector is that the imaging unit is positioned at the opening, and makes a gain adjustment operation of the automatic gain control section stop by the control signal when the detection result of the position detector is that the imaging unit is not positioned at the opening.

Preferably, the image processor includes an image acquisition control section operating in accordance with a control signal to adjust an acquisition speed of an image in accordance with a surrounding brightness of the imaging unit and the controller makes the image acquisition control section operate to adjust an acquisition speed of an image by the control signal when the detection result of the position detector is that the imaging unit is positioned at the opening, and makes an image acquisition speed adjustment operation of the image acquisition control section stop by the control signal when the detection result of the position detector is that the imaging unit is not positioned at the opening.

Preferably, the image processor includes an automatic gain control section operating in accordance with a control signal to adjust a gain for an image signal from the imaging unit in the camera in accordance with a surrounding brightness of the imaging unit and an image acquisition control section operating in accordance with the control signal to adjust an acquisition speed of an image in accordance with a surrounding brightness of the imaging unit and the controller makes the automatic gain control section and the image acquisition control section operate to adjust the gain and adjust an acquisition speed of an image by the control signal when the detection result of the position detector is that the imaging unit is positioned at the opening and makes a gain adjustment operation and an image acquisition speed adjustment operation of the automatic gain control signal and the image acquisition control section stop by the control signal when the detection result of the position detector is that the imaging unit is not positioned at the opening.

According to a second aspect of the present invention, there is provided an electronic device able to display an image captured by imaging unit on a display, comprising a housing at which at least one first opening is formed, a camera unit including casing which had the second opening formed so that the first opening may be faced to, and imaging unit for capturing a picture through the second opening, while constituting rotating member supported to the housing so that the camera unit could position by rotation in the position in which the imaging unit can capture an image through the first opening a position detector for detecting a rotational position of the rotating member, an image processor for performing a predetermined adjustment operation on the captured image unit in accordance with a surrounding brightness, and a controller for making the image processor operate to perform the predetermined adjustment operation when the detection result of the position detector is that the imaging unit is positioned at the first opening and for making the predetermined adjustment operation of the image processor stop when the detection result of the position detector is that the imaging unit is not positioned at the first opening.

Preferably, the image processor includes an automatic gain control section operating in accordance with a control signal to adjust a gain for an image signal from an imaging unit in the camera in accordance with a surrounding brightness of the imaging unit and the controller makes the automatic gain control section operate to adjust the gain by the control signal when the detection result of the position detector is that the imaging unit is positioned at the first opening and makes a gain adjustment operation of the automatic gain control section stop by the control signal when the detection result of the position detector is that the imaging unit is not positioned at the first opening.

Preferably, the image processor includes an image acquisition control section operating in accordance with a control signal and adjusting an acquisition speed of an image in accordance with a surrounding brightness of the imaging unit and the controller makes the image acquisition control section operate to adjust an acquisition speed of an image by the control signal when the detection result of the position detector is that the imaging unit is positioned at the first opening and makes an image acquisition speed adjustment operation of the image acquisition control section stop by the control signal when the detection result of the position detector is that the imaging unit is not positioned at the first opening.

Preferably, the image processor includes an automatic gain control section operating in accordance with a control signal to adjust a gain for an image signal from the imaging unit in the camera in accordance with a surrounding brightness of the imaging unit and an image acquisition control section operating in accordance with the control signal to adjust an acquisition speed of an image in accordance with a surrounding brightness of the imaging unit and the controller makes the automatic gain control section and the image acquisition control section operate to adjust the gain and adjust an acquisition speed of an image by the control signal when the detection result of the position detector is that the imaging unit is positioned at the first opening and makes a gain adjustment operation and an image acquisition speed adjustment operation of the automatic gain control signal and the image acquisition control section stop by the control signal when the detection result of the position detector is that the imaging unit is not positioned at a first opening.

According to a third aspect of the present invention, there is provided an image processing method for a camera device comprising a housing at which at least one opening is formed and a camera unit arranged rotatably inside the housing and arranged so that an imaging unit for capturing an image can be positioned at an opening along with rotation, the image processing method comprising an image processing step for performing a predetermined adjustment operation on the captured image in accordance with a surrounding brightness, a position detection step for detecting a rotational position of the camera, and a control step for activating the image processing step when the imaging unit is positioned at an opening and for deactivating the image processing step operate when the imaging unit is not positioned at an opening.

Preferably, the image processing step includes an automatic gain control step for adjusting a gain for an image signal from the imaging unit in accordance with a surrounding brightness of the imaging unit and the control step activates the automatic gain control step when the imaging unit is positioned at an opening and deactivates the automatic gain control step when the imaging unit is not positioned at an opening.

Preferably, the image processing step includes an image acquisition control step for adjusting an acquisition speed of an image in accordance with a surrounding brightness of the imaging unit and the control step activates the image acquisition control step when the imaging unit is positioned at the opening and deactivates the image acquisition control step when the imaging unit is not positioned at an opening.

### BRIEF DESCRIPTION OF THE DRAWINGS

These and other objects and features of the present invention will become clearer from the following description of the preferred embodiments given with reference to the attached drawings, wherein:

FIG. 1 is a perspective view, as seen from the front, of an embodiment of a mobile phone as an electronic device according to the present invention showing the open state of the mobile phone (mobile terminal) to which the present invention is applied;

FIG. 2 is a perspective view, as seen from the back, of an embodiment of a mobile phone as an electronic device according to the present invention showing the open state of the mobile phone (mobile terminal) to which the present invention is applied;

FIG. 3 is a block diagram of an embodiment of a camera control device according to the present invention;

FIGS. 4A to 4B are views for explaining a control operation of a camera control device;

FIG. 5 is a flow chart for explaining an example of a first control operation of the camera control device;

FIG. 6 is a flow chart for explaining an example of a second control operation of the camera control device;

FIG. 7 is a flow chart for explaining an example of a third control operation of the camera control device;

FIG. 8 is a view of the internal structure of a base side of an upper housing;

FIG. 9 is a perspective view of a state of attachment of a camera unit provided in a mobile phone according to an embodiment of the present invention;

FIG. 10 is a view for explaining a state of connection of a signal ground and a static electricity ground according to an embodiment of the present invention;

FIG. 11 is a perspective view of a camera unit provided in a mobile phone according to an embodiment of the present invention;

FIG. 12 is a cross-sectional view along the line A-A of FIG. 1;

FIG. 13 is an exploded view of a camera unit provided in a mobile phone according to an embodiment of the present invention;

FIG. 14 is an exploded view of a flexible circuit board provided in a mobile phone according to an embodiment of the present invention;

FIG. 15 is a perspective view of a camera unit provided in a mobile phone according to an embodiment of the present invention;

FIG. 16 is an enlarged perspective view, seen from the side, of a flexible circuit board in a mobile phone according to an embodiment of the present invention;

FIG. 17 is a cross-sectional view of a click mechanism provided in a mobile phone according to an embodiment of the present invention; and

FIG. 18 is a perspective view, seen from the bottom, of a casing and relay board unit according to an embodiment of the present invention.

### DESCRIPTION OF THE PREFERRED EMBODIMENTS

Next, preferred embodiments of the present invention will be explained with reference to the attached drawings.

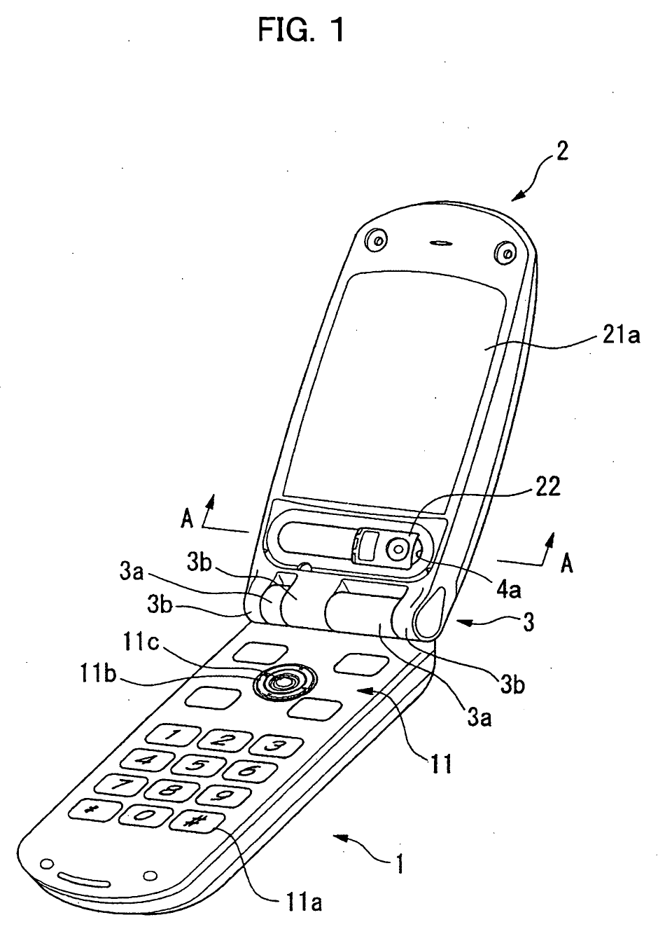

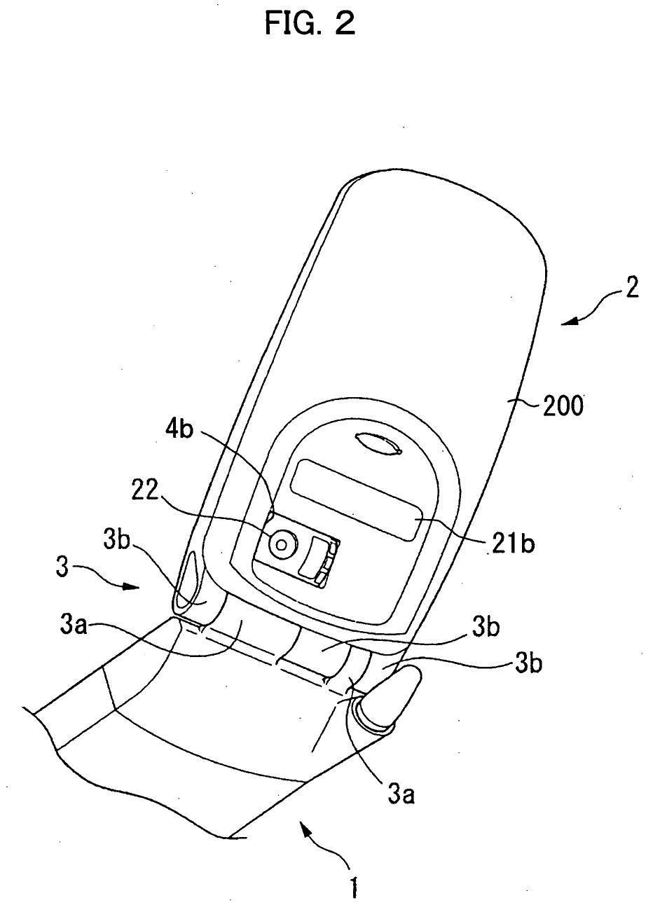

FIG. 1 and FIG. 2 are views of the outer appearance of a mobile phone as an electronic device including a camera control device according to the present invention. FIG. 1 is a perspective view of a mobile phone (mobile terminal) using the present invention in the open state as seen from the front, while FIG. 2 is a perspective view of a mobile phone (mobile terminal) using the present invention in the open state as seen from the back. This mobile phone has, as the mobile terminal body, a lower housing 1, an upper housing 2, and a hinge section 3.

The lower housing 1 has an operation section 11 having ten-key buttons 11a, a cursor button 11b, and an execute button 11c. The upper housing has a display 21 and a rotatable camera unit 22. The front surface of the upper housing 2 (cover side covering base where camera unit 22, circuit board, etc. are mounted) and the back surface (base side where camera unit 22, circuit board, etc. are mounted) are formed with first openings 4a and 4b of predetermined sizes so as to enable the imaging unit of the camera unit 22 to face them and to enable a user to freely adjust the rotational angle by a manual rotating action by the fingers. The display 21 includes a main display 21a formed at the front side of the upper housing 2 (mating surface side of the foldable mobile phone) and a sub display 21b formed at the back side (outer surface when folded).

The hinge section 3 is provided with a lower hinge 3a formed integrally with an end of the lower housing 1 and an upper hinge 3b formed integrally with an end of the upper housing 2. It connects the lower housing 1 and the upper housing 2 and supports the upper housing 2 pivotally with respect to the lower housing 1. This mobile phone can be folded shut about the hinge section 3 so that the surface having the operation section 11 of the lower housing 1 and the surface having the display 21 of the upper housing 2 face each other.

The displays 21a and 21b are comprised of liquid crystal displays (LCD). The main display 21a displays text and other information input by the operation section 11, text, image, and other information stored in a not shown memory built into the mobile phone, images and other information captured using the camera unit 22 by operating the operation section 11, and image and other information transmitted and received by a not shown transceiver built into the mobile phone.

The lower housing 1 houses a circuit board unit. This circuit board unit is connected through a flexible circuit board and a relay board unit arranged in the upper housing 2 with the camera unit 22, a drive system of a vibrator, and a logic board arranged in the upper housing 2. Various operations are performed in accordance with operation of the operation section 11.

In this way, the main display 21a displays image information captured by the camera unit 22. The mobile phone has a camera control device of the camera unit 22 arranged in the logic board and a rotational mechanism arranged in the upper housing 2. Here, before explaining the internal structure of the mobile phone, the camera control device will be explained mainly focusing on the control circuit.

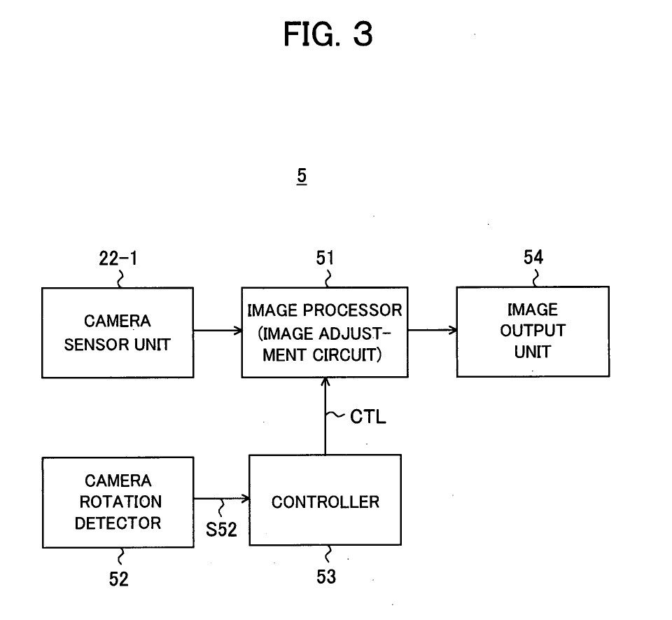

FIG. 3 is a block diagram of an embodiment of the camera control device according to the present invention.

The camera control device 5, as shown in FIG. 3, has an image processor 51 for performing image processing including an image adjustment circuit for performing a predetermined adjustment operation in accordance with the surrounding brightness of the sensor unit (imaging unit) 22-1 including a lens on an image captured by the sensor unit 22-1 from an imaging unit of the camera unit 22 constituted by a CCD or CMOS sensor etc., a rotational position detector 52 for detecting the rotational position of a rotating member 23 described later after the camera unit 22 and outputting a detection signal S52, a controller 53 for receiving a detection signal S52 of the rotational position detector 52, making an image adjustment circuit of the image processor 51 operate to perform a predetermined adjustment operation by a control signal CTL when judging that the imaging unit is positioned at the first opening 4a or 4b, and stopping the adjustment operation of the image adjustment circuit processor 51 by the control signal CTL when judging that the imaging unit is not positioned at the first opening 4a or 4b, and an image output unit 54 for displaying an image processed by the image processor 51 on the main display 21a.

The image adjustment circuit of the image processor 51 includes an automatic gain control circuit operating in accordance with the control signal CTL and adjusting the gain for the image in accordance with the surrounding brightness of the imaging unit and an image acquisition control circuit operating in accordance with the control signal CTL and adjusting the image acquisition speed in accordance with the surrounding brightness of the imaging unit. When receiving the detection signal S52 of the rotational position detector 52 and judging that the imaging unit 22-1 is positioned at (facing) the first opening 4a or 4b, the controller 53 makes the automatic gain control circuit and the image acquisition control circuit operate to adjust the gain and adjust the image acquisition speed by the control signal CTL.

The automatic gain control circuit raises the gain when the surroundings are dark and lowers the gain when they are conversely bright. The gain is adjusted in accordance with the image signal as for example the follows: The CCD or other imaging device used in a digital camera (camera sensor unit 22-1) outputs information on the acquired colors to the image processor 51 as color information for each pixel when instructed to start shooting. This color information includes information relating to the luminance and tint, white balance, etc. The image processor 51 first converts the information from an analog to digital format, amplifies it by the automatic gain control circuit, then converts this to YUV and further RGB signals which it then supplies to the image output unit 54.

The controller 53 monitors the color information of the image processor 51. When judging that the surroundings are dark, it changes the normally 3 dB amplification rate to for example 4 dB by the automatic gain control circuit. Conversely, when judging that the surroundings are bright, it instructs the image processor 51 so as to make it 2 dB. For example, it adjusts the gain by this processing. In addition, the image processor 51 also performs processing to adjust the exposure time etc., but naturally these adjustments also relate to gain adjustment.

The image acquisition control circuit changes the image acquisition speed of the camera (frame rate) in accordance with the surrounding brightness. When dark, it decreases the speed so as to lengthen the light acquisition time, while conversely when bright, it increases the speed so as to shorten the light acquisition time. The image acquisition control circuit controls the rate to five stages of for example 3.75 frames/sec, 5 frames/sec, 7.5 frames/sec, 10 frames/sec, and 15 frames/sec.

On the other hand, when receiving the detection signal S52 of the rotational position detector 52 and judging that the imaging unit 22-1 is not positioned at (facing) the first opening 4a or 4b, the controller 53 stops the gain adjustment operation of the automatic gain control circuit and the image acquisition speed adjustment operation of the image acquisition control circuit by the control signal CTL.

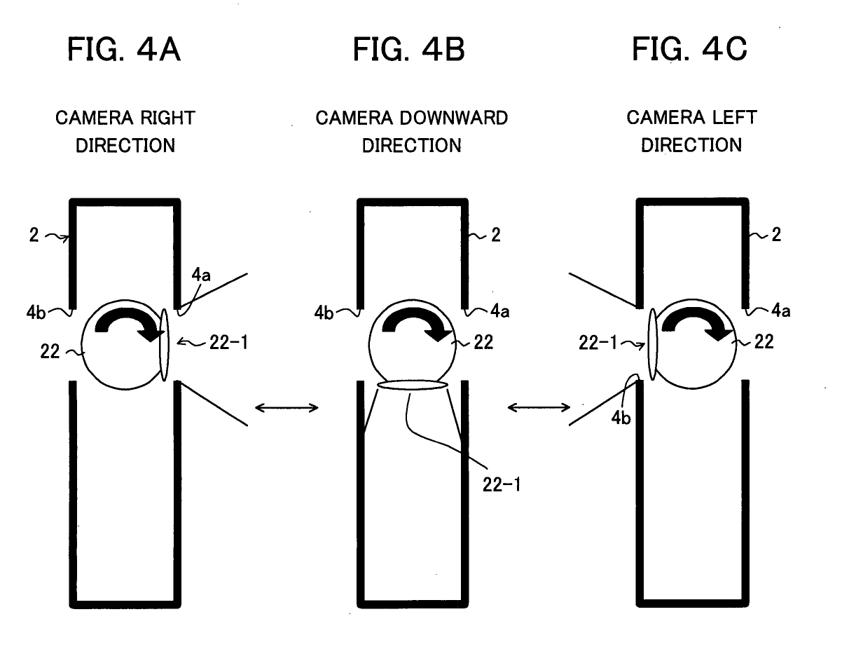

Below, the control operation of the camera control device 5 will be explained with reference to FIGS. 4A to 4C and FIG. 5 to FIG. 7. Here, the explanation will be given with the imaging unit (sensor unit) 22-1 positioned at (facing) the opening 4a of the upper housing 2 as the right direction as shown in FIG. 4A, with the imaging unit (sensor unit) 22-1 positioned inside (facing) the inside of the upper housing 2 as the downward direction, and with the imaging unit (sensor unit) 22-1 positioned (facing) the opening 4b of the upper housing 2 as the left direction as shown in FIG. 4B.

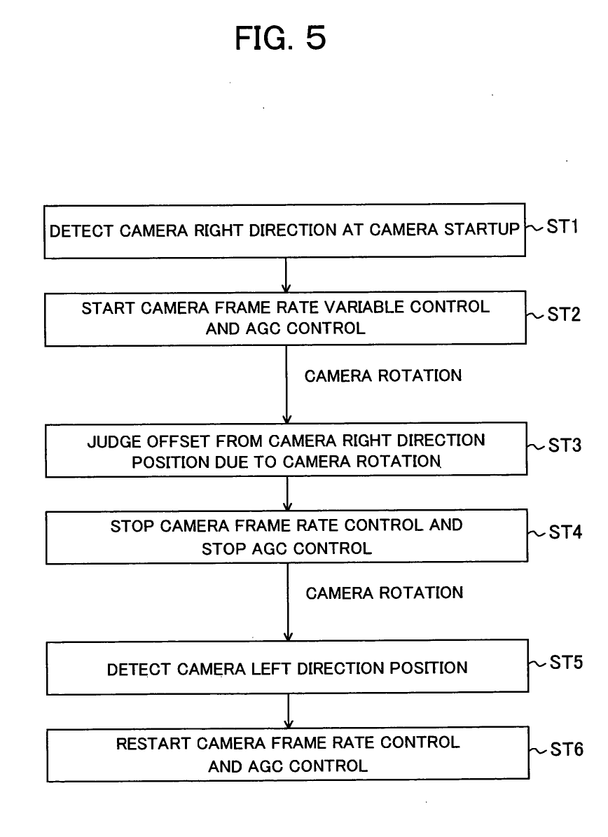

As shown in FIG. 5, when during camera operation the rotational position detector 52 detects the rotational position showing that the camera is in the right direction (left direction), it outputs a detection signal S52 showing this to the controller 53 (ST1).

The controller 53 receives the detection signal S52, judges that the imaging unit 22-1 is positioned at (faces) the first opening 4a, and makes the automatic gain control circuit and the image acquisition control circuit operate to adjust the gain and adjust the image acquisition speed by the control signal CTL (ST2).

Here, when the camera unit 22 has been rotated and the rotational position detector 52 cannot detect the direction of the camera (ST3), the controller 53 judges that the imaging unit 22-1 is not in the right direction or left direction, that is, is positioned at (faces) the inside of the housing, and stops the gain adjustment operation of the automatic gain control circuit and the image acquisition speed adjustment operation of the image acquisition control circuit by the control circuit CTL (ST4).

Further, when the camera unit 22 has been further rotated and the rotational position detector 52 detects the rotational position showing that the camera is in the left direction (right direction), a detection signal S52 showing that effect is output to the controller 53 (ST5).

The controller 53 receives the detection signal S52, judges that the imaging unit 22-1 is positioned at (faces) the first opening 4b, and makes the automatic gain control circuit and the image acquisition control circuit operate to adjust the gain and adjust the image acquisition speed by the control signal CTL (ST6).

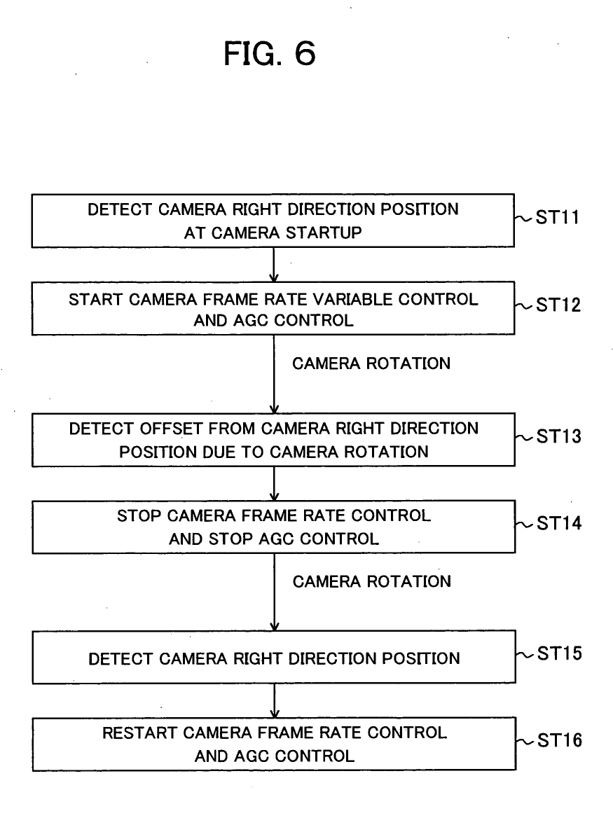

As shown in FIG. 6, when during camera operation the rotational position detector 52 detects the rotational position showing that the camera is in the right direction (left direction), it outputs a detection signal S52 showing this to the controller 53 (ST11).

The controller 53 receives the detection signal S52, judges that the imaging unit 22-1 is positioned at (faces) the first opening 4a, and makes the automatic gain control circuit and the image acquisition control circuit operate to adjust the gain and adjust the image acquisition speed by the control signal CTL (ST12).

Here, when the camera unit 22 has been rotated and the rotational position detector 52 cannot detect the direction of the camera (ST13), the controller 53 judges that the imaging unit 22-1 is not in the right direction or left direction, that is, is positioned at (faces) the inside of the housing, and stops the gain adjustment operation of the automatic gain control circuit and the image acquisition speed adjustment operation of the image acquisition control circuit by the control circuit CTL (ST14).

Further, when the camera unit 22 is rotated in reverse and the rotational position detector 52 detects the rotational position showing that the camera is in the right direction (left direction), the rotational position detector 52 outputs a detection signal S52 showing that effect to the controller 53 (ST15).

The controller 53 receives the detection signal S52, judges that the imaging unit 22-1 is positioned at (faces) the first opening 4a, and makes the automatic gain control circuit and the image acquisition control circuit operate again to adjust the gain and adjust the image acquisition speed by the control signal CTL (STl6).

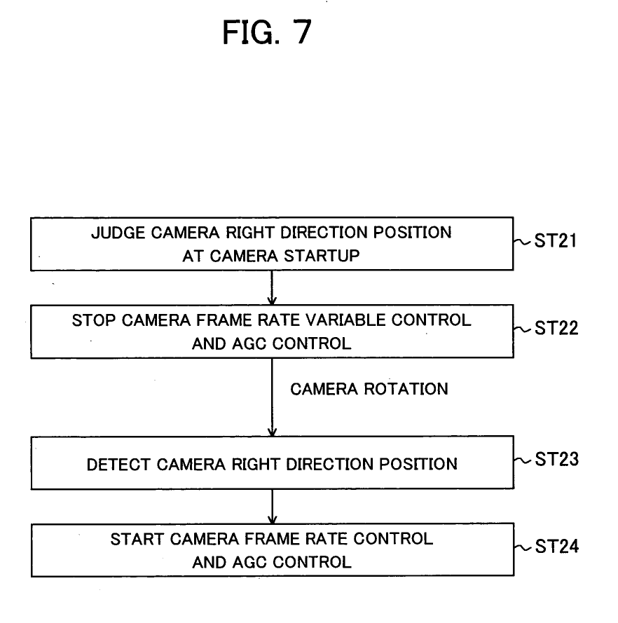

Further, as shown in FIG. 7, when during camera operation the orientation of the camera cannot be detected (ST21), the controller 53 judges that the imaging unit 22-1 is not in the right direction or left direction, that is, is positioned at (faces) the inside of the housing, and stops the gain adjustment operation of the automatic gain control circuit and the image acquisition speed adjustment operation of the image acquisition control circuit by the control circuit CTL (ST22)

Further, when the camera unit 22 has been further rotated and the rotational position detector 52 detects the rotational position showing.that the camera is in the right direction, the rotational position detector 52 outputs a detection signal S52 showing that effect to the controller 53 (ST23).

The controller 53 receives the detection signal S52, judges that the imaging unit 22-1 is positioned at (faces) the first opening 4a, and makes the automatic gain control circuit and the image acquisition control circuit operate to adjust the gain and adjust the image acquisition speed by the control signal CTL (ST24).

In this way, the camera control device 5 according to the present embodiment has a rotational position detector 52 for detecting the rotational position of the rotating member 23 described later after the camera unit 22 and outputting a detection signal S52 and a controller 53 for receiving a detection signal S52 of the rotational position detector 52, making an automatic gain control circuit and an image acquisition control circuit operate to adjust the gain and adjust the image acquisition speed by a control signal CTL when judging that the imaging unit 22-1 is positioned at (facing) the first opening 4a or 4b, and stopping the gain adjustment operation of the automatic gain control circuit and image acquisition speed adjustment operation of the image acquisition control circuit by the control signal CTL when judging that the imaging unit 22-1 is not positioned at (facing) the first opening 4a or 4b, so it is possible to shorten the convergence time in a change of the AGC gain of the camera and the convergence time in a change of the image acquisition speed.

That is, it is possible to avoid automatic adjustment to match with completely dark surroundings due to the surroundings become completely dark when the camera faces the inside of the housing in the middle of rotation. Once the completely dark state is matched with, considerable time is required for readjustment, so by stopping the adjustment operation, it is possible to shorten the time required for image adjustment.

Further, when the imaging unit 22-1 is positioned at the opening 4a or 4b, the image processor 51 executes image adjustments such as gain adjustment and changes of the frame rate while storing the data relating to the adjustments in a buffer memory. At this time, when judging that the imaging unit 22-1 is off from the position of an opening, the data relating to the image adjustment is not updated. Next, when the imaging unit 22-1 is positioned at an opening again, the data remaining in the buffer memory is used for the image adjustment. Due to this, image adjustment is performed at the completely dark parts (state where imaging unit 22-1 is positioned inside the housing). The data used for the image adjustment inside the buffer memory is not unnecessarily updated, so it is possible to use the data of the image adjustment immediately before to start the adjustment and the processing speed is improved.

Further, when the brightness is expected to greatly differ due to the direction of the imaging unit, it is also possible to perform different processing. For example, when the imaging unit 22-1 has been positioned at the opening 4a, if a rotational operation has been performed and it is judged that the unit is now off from position from the opening, the image adjustment data in the buffer memory is maintained for the time being. If configuring the system so that, after this, when detecting that the imaging unit is positioned again at the opening 4a, the previous data of the buffer memory is used for adjustment of the image again and when judging that the unit is positioned at the opening 4b, the data inside the buffer memory is dumped, it is also possible to improve the processing speed more when the brightness will greatly differ depending on the direction of the imaging unit.

Below, the internal structure of the upper housing including the functions of the rotational position detector will be explained.

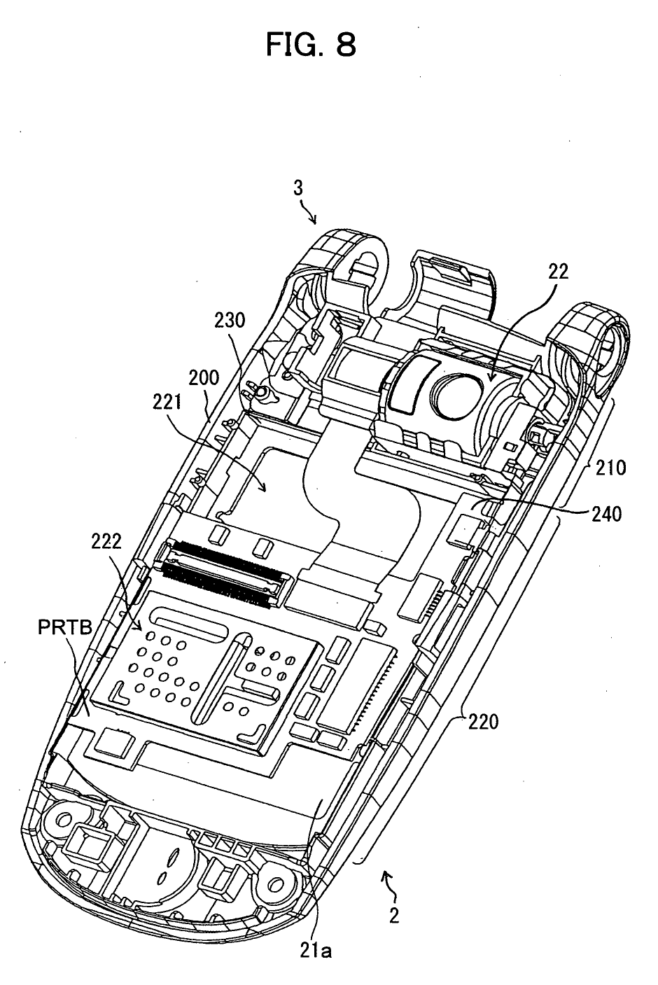

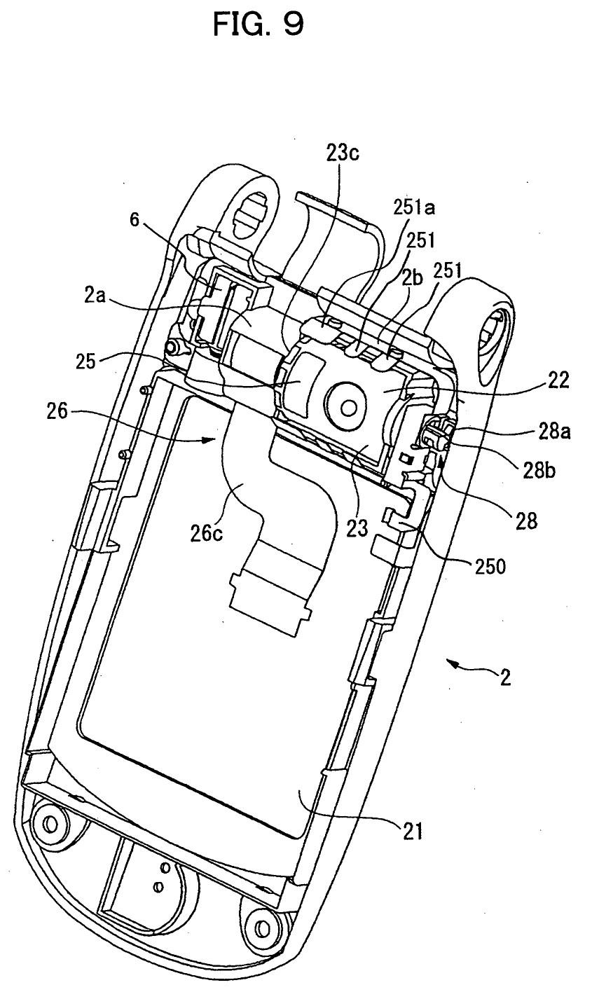

FIG. 8 and FIG. 9 are views of the internal structure of the upper housing 2. The inside of the base 200 of the upper housing 2 is formed with a drive area 210 for arranging the drive system of the camera unit 22, the vibrator motor, etc. near the hinge section 3 and a logic area 220 for arranging the main display (LCD) 21a, the sub LCD (not shown in FIG. 3) 21b arranged at the surface at the opposite side from the main LCD 21, the DSP board PRTB, etc. and adjoining the drive area 210 through a wall-shaped boundary 230. Note that at the area 221 of the logic area 220, the sub LCD 21 is mounted as a predetermined unit so as to sandwich the flexible circuit board with the inside surface of the base 200.

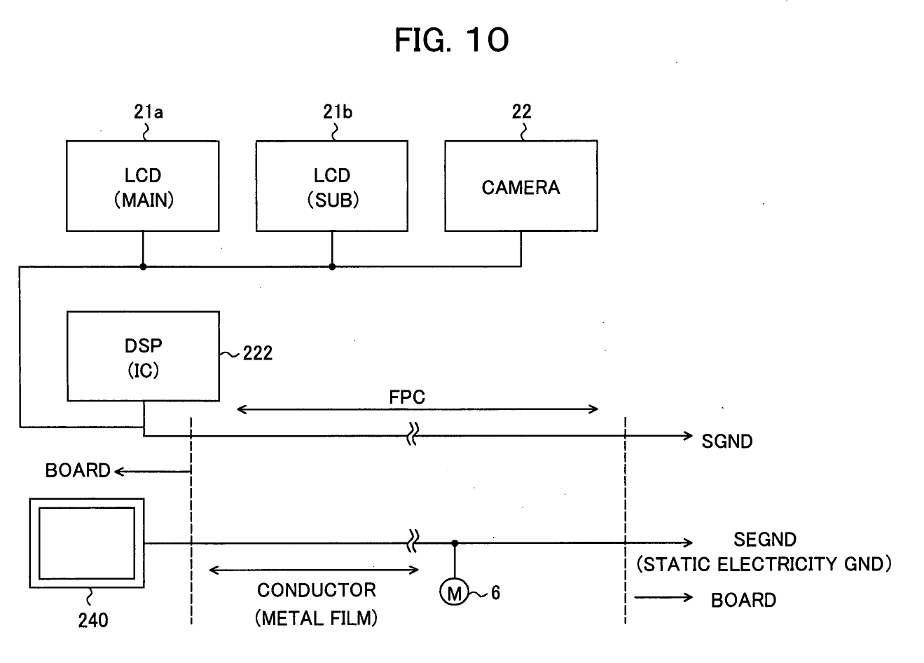

In the present embodiment, as shown in FIG. 10, the signal ground and the static electricity ground are formed separately. A static electricity ground 240 is formed at the periphery of the DSP board PRTB. The DSP board PRTB is formed with the image processor 51, controller 52, and image output unit 54 of the camera control device 5. Basically, as shown in FIG. 10, the signal ground SGND is connected to the main LCD 21a, sub LCD 21b, camera unit 22, DSP (IC) 222, etc. through the flexible circuit board etc. The static electricity ground SEGND (240) has a vibrator motor 6 connected to it by a conductor (metal film) as explained later.

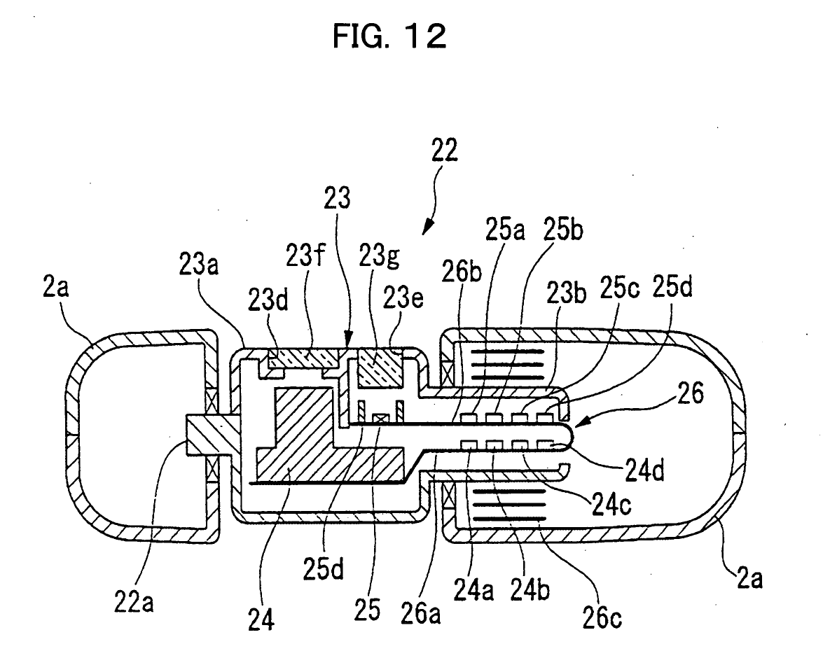

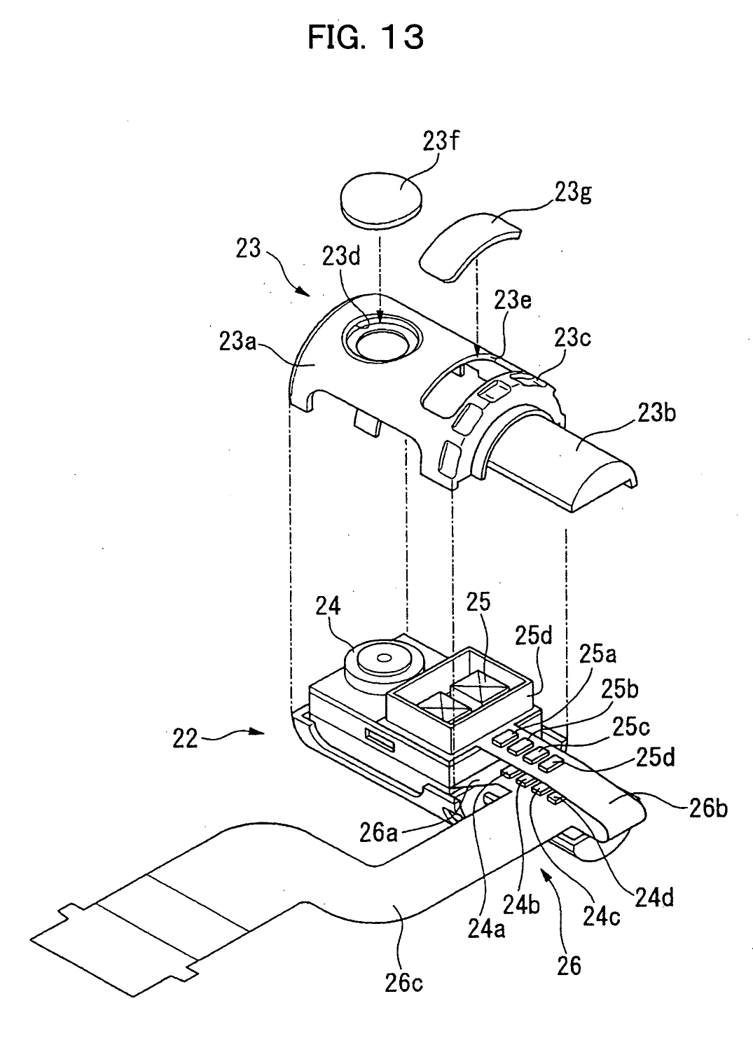

Next, the camera unit 22 will be explained in relation to FIG. 9 and FIG. 11 to FIG. 13.

The camera unit 22, as shown in the figure, is built into the upper housing 2 and is formed into a substantially cylindrical shape so as to extend in the width direction of the upper housing 2. The camera unit 22 is provided with a rotating member 23 having a shaft 22a and supported rotatably at the two ends of the shaft 22a in the upper housing 2, a camera module 24 serving as the imaging unit arranged in the rotating member 23 and light emitting unit 25, and a flexible circuit board 26 provided at an end of the rotating member 23 and connected to the camera module 24 and light emitting unit 25.

When the camera unit 22 takes a picture in the state with the camera module 24 facing the main display 21 side as shown in FIG. 1, it is possible to take a picture of an object at the main display 21a side while viewing the main display 21a. On the other hand, when the end of the rotating member 23 is turned by a finger etc. to turn the rotating member 23 180 degrees inside the upper housing 2 from the state where the camera module 24 faces the main display 21a side, as shown in FIG. 2, the camera module 24 will face the opposite side of the main display 21a. If taking a picture in this state, an object at the opposite side to the main display 21 can be shot while viewing the main display 21a.

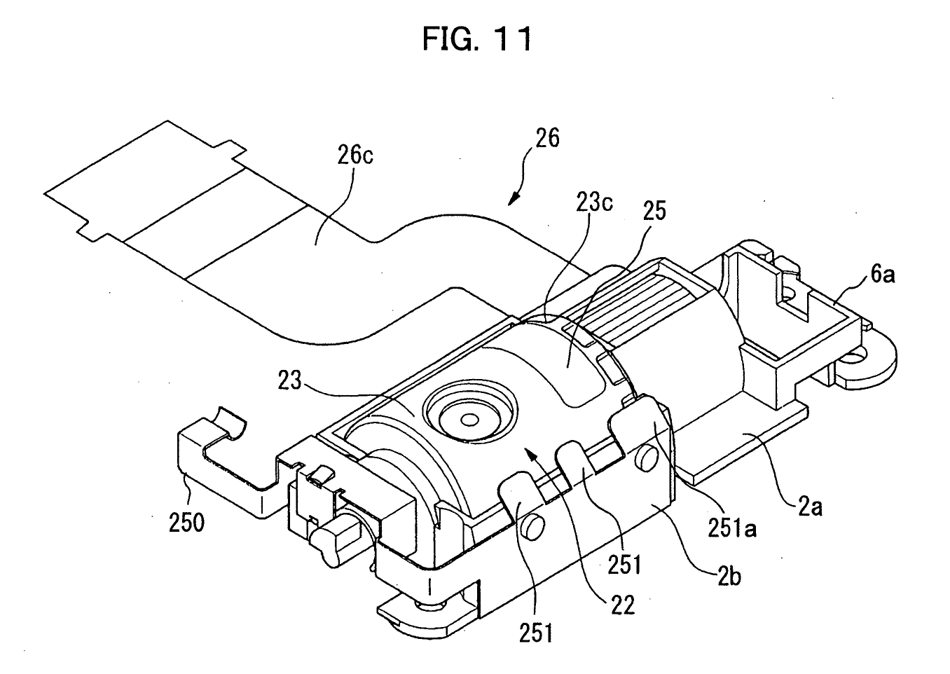

The camera unit 22 is housed in a casing 2a inside the upper housing 2. The outside of the casing 2a is set with a second conductor 2b comprised of metal film for dealing with the static electricity. Further, the casing 2a has a holder 6 for holding the vibrator motor 5 adjoining it in the longitudinal direction. The casing 2a, as shown in FIG. 9 and FIG. 11, is open at the top and bottom. A rotating member 23 is housed in the opening. The second conductor 2b is set so as to be arranged at three sides out of the four sides of the casing 2a.

One end of the second conductor 2b is positioned at the logic area 220 when the casing 2a is held in the first holding part of the drive area 210. A contact terminal 250 is formed able to be connected to the static electricity ground 240 formed around the DSP board PRTB arranged on that logic area 220.

Above and below the second conductor 2b positioned at the two sides of the casing 2a in the longitudinal direction, a plurality of tabs are provided so as to run along the side surface of the rotating member 23 forming a cylindrical shape for the purpose of absorbing the static electricity and running it through the contact terminal 250 to the static electricity ground 240. The plurality of tabs 251 are formed so as to differ in width according to their arrangement positions. For example, the tab 251a positioned close to the light emitting unit 25 is formed wider than the other tabs for facilitating absorption of the static electricity.

By forming a plurality of tabs for absorbing the static electricity in this way, it becomes easy to fix the position of the rotating member 23 with respect to the casing 2a, it is possible to ease action of the force or impact from the outside on the rotating member 23, the housing no longer has to be made of metal, and the cost of the materials can be kept low. Here, the explanation was given of the case of forming a plurality of tabs for absorbing the static electricity, but it is also possible to absorb static electricity using a single sheet. This is more effective for easing the action of external force or shock.

The rotating member 23 is provided with a large diameter part 23a and small diameter part 23b coaxially but differing in diameter. The large diameter part 23a and small diameter part 23b are connected with each other. Further, the end of the large diameter part 23a at the small diameter part 23b side is provided at its outer circumference with a plurality of recesses 23c so as to enable the rotating member 23 to be easily rotated by the finger. Further, the rotating member 23 made of two parts can be separated so that the camera module 24, light emitting unit 25, and flexible circuit board 26 can be inserted inside. Further, the side surfaces of the rotating member 23 are provided with openings 23d and 23e so that the camera sensor unit constituted by the camera module 24 and light emitting unit 25 can be seen from the outside. These openings 23d and 23e are provided with transparent windows 23f and 23g so as to protect the shooting window of the camera module 24 and the light emitting surface of the light emitting unit 25.

The camera module 24 is arranged on one extension 26a of a later mentioned flexible circuit board 26 and is electrically connected to the extension 26a. The camera module 24 takes a picture of an object by a not shown drive unit. For example, a CCD or CMOS sensor etc. may be used. The light emitting unit 25 is arranged on another extension 26b of the flexible circuit board 26 and is electrically connected to that extension 26b. This light emitting unit 25 is designed to emit light simultaneously with shooting of an object by a not shown drive unit when shooting the object by the camera module 24. For example, a white LED is used.

As explained above, the tab 251a positioned near the light emitting unit 25 is formed wider than the other tabs so as to facilitate the absorption of the static electricity.

The light emitted from the light emitting unit 25 is strong light such as used for assisting imaging. When the glass substrate of the LCD etc. is strongly irradiated, the LCD may malfunction due to the problem of current leakage due to the light emitted from the TFTs. Forming the tab 251a positioned near the light emitting unit 25 wider than the other tabs helps to prevent malfunctions of the LCD.

Formation of the tabs 251 and 251a in a state running along the side of the cylindrical rotating member 23 is easy. When holding the casing 2a in the first holding part 211, the tabs 251 and 251a enter into the recesses 211a formed in the first holding part of the drive area 210, so positioning itself is easy.

Further, in this case, it is possible to provide the tabs right up close to where they would be touched by the fingers in the state holding the strength of the housing without exposing metal such as tabs at the housing. As a result, it is easy to absorb the static electricity of the finger turning the camera unit 22 and in turn possible to prevent the static electricity from entering into the camera unit 22. Since it is possible to effectively prevent entry of static electricity to the camera unit 22 in this way, a clearer captured image with extremely little noise can be obtained.

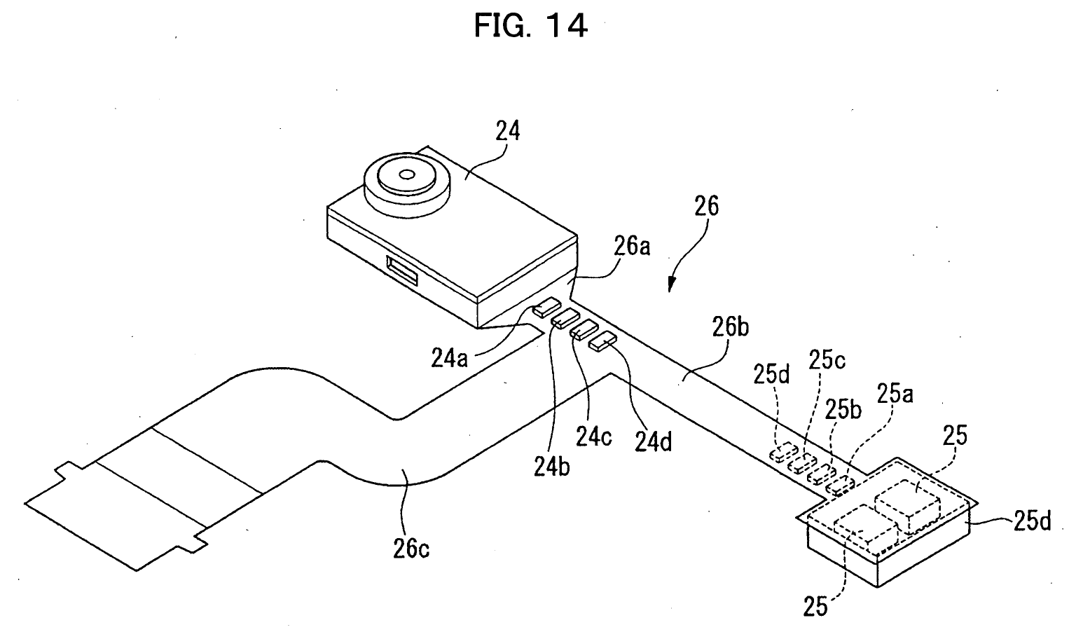

The flexible circuit board 26, as shown in FIG. 14, has one extension 26a and another extension 26b extending in the axial direction of the rotating member 23 and has an extension 26c extending vertical to the axial direction of the rotating member 23, whereby a substantially T-shape is formed. This flexible circuit board 26 is provided with a capacitor 24a, resistor 24b, ferrite bead 24c, and diode 24d serving as control parts of the camera module 24 at the extension 26a and with a capacitor 24a, resistor 25b, ferrite bead 25c, and diode 25d as control parts of the light emitting unit 25 at the other extension 26b. These control-parts are arranged near the camera module 24 and light emitting unit 25. The extension 26c of the flexible circuit board 26 is electrically connected to the camera unit 22.

The flexible circuit board 26 is folded back at the extension 26b and superposed over the extension 26a. At this time, the camera module 24 and the light emitting unit 25 are both arranged so that they can be seen from the openings 23d and 23e of the rotating member 23. Further, in the state where the flexible circuit board 26 is folded back at the extension 26b and superposed over the extension 24a, the extension 26a and the extension 26b are housed in the rotating member 23. The extension 26b is provided with a reflector 25d so as to cover the surroundings of the light emitting unit 25 so as to reflect light emitted from the light emitting unit 25.

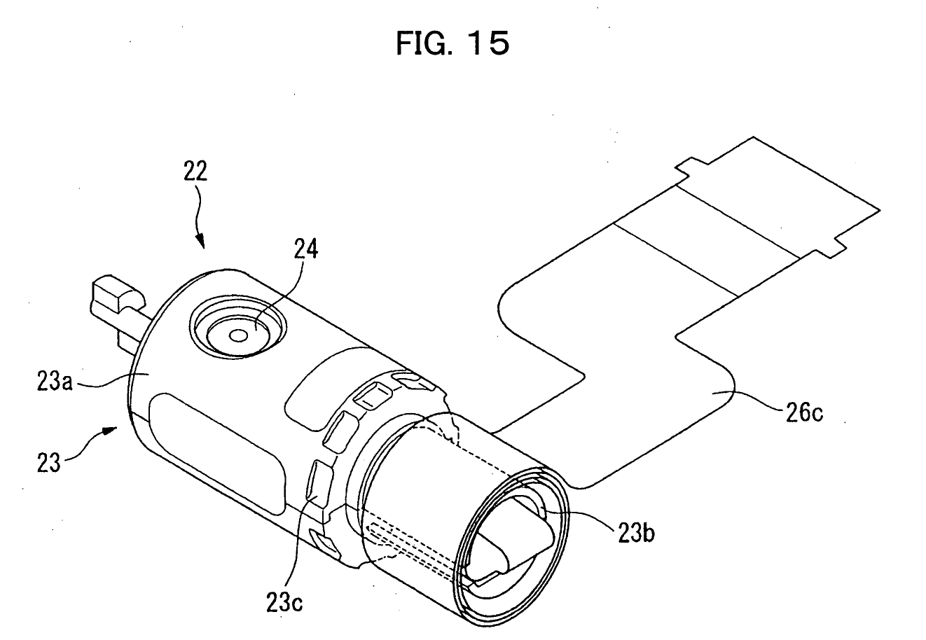

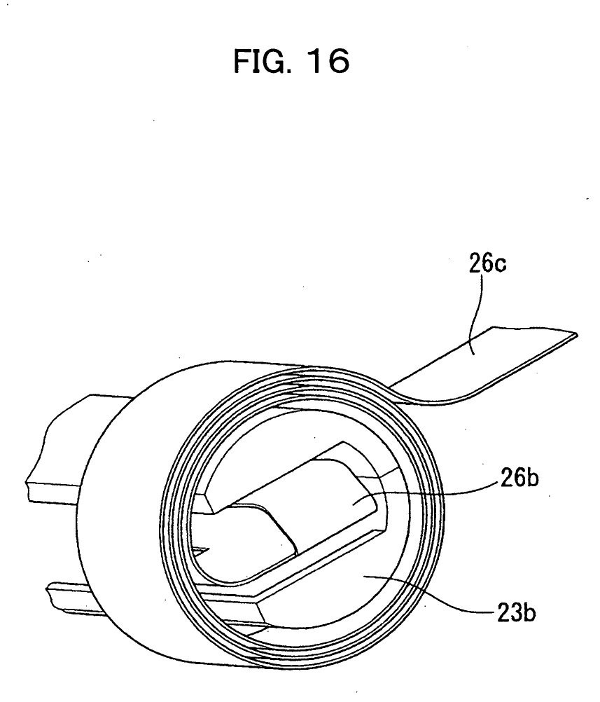

The flexible circuit board 26 extends to the outside of the rotating member 23 at the extension 26c when the parts of the rotating member 23 are joined and camera module 24, light emitting unit 25, and other components are held in the rotating member 23. This extension 26c, as shown in FIG. 15 and FIG. 16, is wound around the outer circumference of the small diameter part 23b of the rotating member 23 with some clearance. The camera unit 22 is held in the casing 2a in the state with the extension 26c wound around the outer circumference of the small diameter part 23b of the rotating member 23 with some clearance.

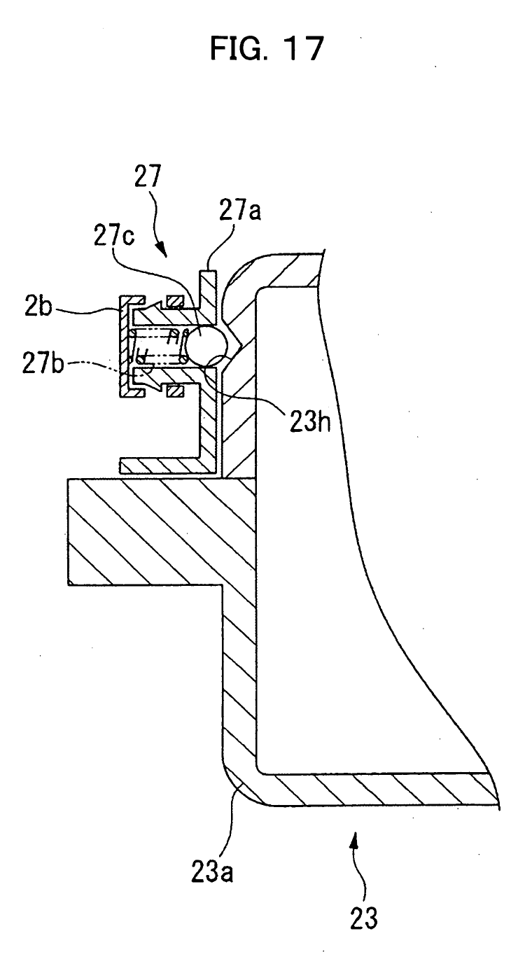

The end of the large diameter part 23a forming the rotating member 23 is provided with a click mechanism 27 for fixing the rotated camera unit 22 shown in FIG. 17 at a predetermined position. The click mechanism 27 is provided with a casing 27a, a spring 27b provided in the casing 27a, and a metal ball 27c pushed against the rotating member 23 by the spring 27b.

The spring 27b is pressed from outside of the casing 27a, by the metal sheet 2b provided at the outside of the casing 2a. The end of the large diameter part 23a which the metal ball 27c contacts is provided with a recess 23h. When stopping the camera unit 22 turned by the finger, the metal ball 27c pressed against the end of the large diameter part 23a by the elasticity of the spring 27b fits into the recess 23h, whereby the camera unit 22 is fixed at a predetermined position.

Further, the end of the camera unit 22 is provided with a rotational position detection switch 28 serving as a position detecting means for detecting the position when the camera unit 22 is rotated. The rotational position detection switch 28 is comprised of two switches 28a and 28b and detects the position of the camera unit 22 set to any of the position where the transparent window 23f of the camera module 24 faces the first opening 4a (one surface), the position where the transparent window 23f of the camera module 24 faces the opening 4b (other surface), and the position where the transparent window 23f of the camera module 24 is hidden.

For example, when the transparent window 23f of the camera module 24 is at the position facing one surface, the switch 28a is turned on and the switch 28b is turned off. When the transparent window 23f of the camera module 24 is at the position facing the other surface, the switch 28a is turned off and the switch 28b is turned on. When the transparent window 23f of the camera module 24 is at the hidden position, the switch 28a and the switch 28b are both turned off. The on/off states of the switches 28a and 28b pass through the flexible circuit board and are transferred to the controller 53 mounted on the DSP board PRTB as the detection signal S52. Using the signal, the controller 53 performs control to start and stop the operation for adjustment of the AGC gain and image acquisition speed.

The drive area 210 of the upper housing 2 is provided with a second holding part for holding the flexible circuit board or other parts of the relay board unit formed so as to overlay the first holding part for holding the casing 2a mounting the camera unit 22 and vibrator motor 6 in parallel. Further, the relay board unit is provided so as to be positioned between the holding part of the wound part of the flexible circuit board 26 of the casing 2a of the camera unit 22 and the holding part 6a of the vibrator motor 6 and the flat surface of the base 200.

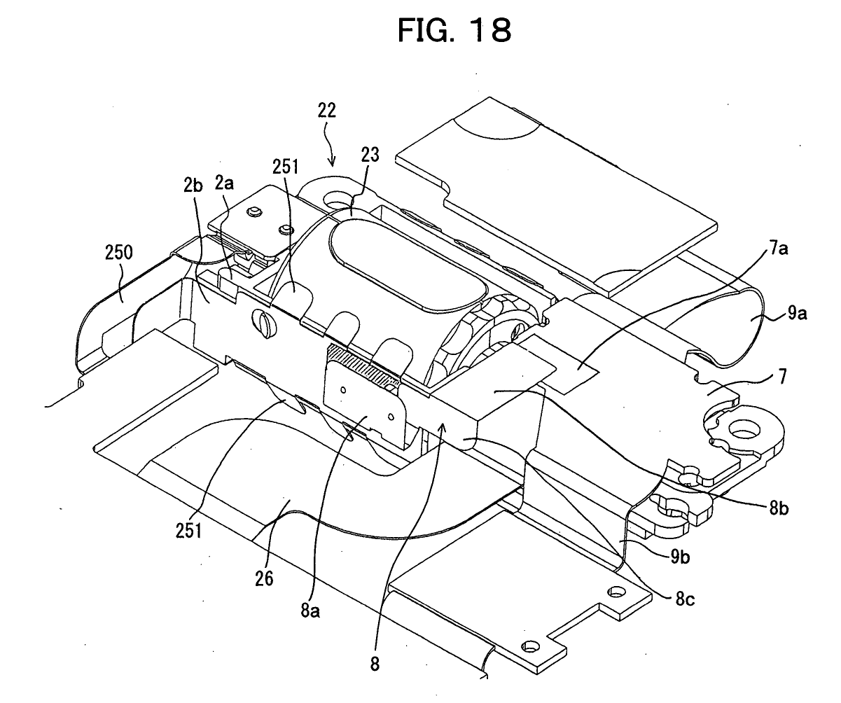

FIG. 18 is a perspective view of the casing 2a and the relay board unit 7 seen from the bottom surface. As shown in FIG. 18, at the bottom surface of the relay board unit 7, for example the ground of the vibrator motor 6 and static electricity ground 7a of the flexible circuit board are exposed.

Further, in the present embodiment, an engagement part 8a is formed able to engage with a predetermined position of the boundary 230 between the drive area 210 and the logic area 220. It has a first conductor 8 made of metal film formed with a first connector 8b able to reach and contact the static electricity ground 7a exposed at the relay board unit 7 from the side of the casing 2a and a second connector 8c able to contact a second conductor 2b set from the side of the casing 2a in the state with the engagement part 8a engaged at the predetermined position of the boundary 230 and the first connector 8b connected with the static electricity ground 7a exposed at the relay board unit 7.

The static electricity ground 7a exposed at the relay board unit 7, the first connector 8b and second connector 8c of the first conductor 8, the second conductor 2b, the contact terminal 250, and the static electricity ground 240 formed at the periphery of the DSP board PRTB are connected. The static electricity ground line is formed separate from the signal line by the first conductor 8 and second conductor 2b made of metal film.

Further, the flexible circuit board shown by reference numeral 9a in FIG. 18 is a flexible circuit board connecting the circuit board unit held in the lower housing 1 and the relay board unit 7. The flexible circuit board shown by reference numeral 9b is a flexible circuit board for connecting the relay board unit 7 arranged at the upper housing 2 and the DSP board PRTB arranged at the logic area 220. The flexible circuit board 9a includes a signal ground and static electricity ground. The static electricity ground is routed separately from the relay board unit 7. As explained above, it passes through the static electricity ground 7a, the first connector 8b and second connector 8c of the first conductor 8, the second conductor 2b, the contact terminal 250, and the static electricity ground 240 formed at the periphery of the DSP board PRTB, while the signal ground is connected from the relay board unit 7 as is through the flexible circuit board 9b to the DSP board PRTB. That is, in the present embodiment, regardless of the extremely narrow limited area in the housing, a ground interconnect is realized for preventing the signal ground and the static electricity ground from approaching each other. As a result, due to the electromagnetic inductance, capacitance coupling, etc. which easily occur when two grounds are close, it is possible to prevent the entry of static electricity noise to the signal ground where the effect of noise is desired to be avoided as much as possible and in turn to prevent malfunctions of the logic circuits.

Next, the function and action of the mobile phone of the above configuration will be explained.

First, the engagement part 8a of the first conductor 8 is engaged at a predetermined position of the boundary 230 of the drive area 210 and the logic area 220 of the upper housing 2 to position the front end of the first connector 8b at a predetermined position of the second holding part of the drive area 210. At this time, the second connector 8c of the first conductor 8 can be brought into contact with the second conductor 2b running along the boundary 230 and set at the casing 2a to be held in the first holding part later. In this state, the relay board unit 7 is set in the second holding part with the static electricity ground 7a exposed at the relay board unit 7 facing down. Due to this, the static electricity ground 7a and the first connector 8b of the first conductor 8 are electrically connected. Further, the logic area 220 is set at a predetermined position with a DSP board PRTB around which a static electricity ground 240 is formed. Further, the flexible circuit board 9b connected to the relay board unit 7 is connected to a predetermined connector of the DSP board PRTB.

Next, the casing 2a holding the camera unit 22 and the vibrator motor 6 is placed in the first holding part of the drive area 210. Due to this, the connectors of the motor 6 of the casing 2a are electrically connected with not shown terminals of the relay board unit 7. The relay board unit 7 receives a predetermined pressing force from the casing 2a so the electrical connection of the static electricity ground 7a and the first connector 8b of the first conductor 8 is stably held. The second connector 8c of the first conductor 8 contacts the second conductor 2b set at the casing 2a and that state is stably held. The contact terminal 250 having elasticity formed at the second conductor 2b contacts the static electricity ground 240 at the periphery of the DSP board PRTB arranged at the logic area 220 and that state is held. As a result, the static electricity ground 7a exposed at the relay board unit 7, the first connector 8b and the second connector 8c of the first conductor 8, the second conductor 2b, the contact terminal 250, and the static electricity ground 240 formed at the periphery of the DSP board PRTB are connected. The static electricity ground line is formed by the first conductor 8 and second conductor 2b made of metal film separate from the signal line. The camera flexible circuit board 26 is connected to predetermined contacts of the DSP board PRTB. The sub LCD 21b mounted at the area 221 of the logic area 220 is set as a predetermined unit so as to sandwich the flexible circuit board 26 with the inside surface of the base 200.

When using a mobile phone having this structure to take a picture of an object, the camera module 24 and light emitting unit 25 are made to face the object by rotating the transparent window 23f of the camera module 24 provided at the camera unit 22, then depressing the execute button 11c of the operation section 11 provided at the lower housing 1. In this case, since the top and bottom of the second conductor 2b positioned at two sides of the casing 2a in the longitudinal direction are formed with a plurality of tabs 251 running along the side of the cylindrical rotating member 23 for the purpose of absorbing static electricity and running it through the contact terminal 250 to the static electricity ground 240, the static electricity to the camera unit 22 is discharged through the tabs 251, second conductor 2b, and the contact terminal 250 to the static electricity ground 240 and the effect of the static electricity to the camera unit 22 is effectively removed. Therefore, malfunctions and destruction of the image processor 51, controller 52, etc. are prevented.

Further, when using the mobile phone to take a picture of an object, the upper housing 2 superposed with the lower housing 1 is opened by the hand from the state where the mobile phone is folded up for non-use, the operation section 11 is operated to set up the shot while viewing the display 21, the light emitting unit 25 is set to operate simultaneously with the shot in accordance with need, the camera unit 22 provided at the upper housing 2 is rotated to make the transparent window 23f and transparent window 23g face the direction of the object, and the execute button 11c is depressed for the shot.

At this time, when during camera operation the rotational position detector 52 detects the rotational position showing that the camera is for example facing the opening 4a and the switch 28a is on, it outputs a detection signal S52 showing this to the controller 53.

The controller 53 receives the detection signal S52, judges that the imaging unit 22-1 is positioned at (faces) the first opening 4a, and makes the automatic gain control circuit and image acquisition control circuit operate to adjust the gain and adjust the image acquisition speed by the control signal CTL.

Further, when the camera unit 22 has been rotated and does not face the opening 4a or 4b and both the switches 28a and 28b are off, the rotational position detector 52 outputs a detection signal S52 showing that effect to the controller 53.

The controller 53 receives the detection signal S52, judges that the imaging unit 22-1 is positioned (faces) inside the housing, and stops the gain adjustment operation and image acquisition speed adjustment operation of the automatic gain control circuit and image acquisition control circuit.

Further, when the camera unit 22 has been further rotated, the camera faces the opening 4b, and the switch 28b is on, the rotational position detector 52 outputs a detection signal S52 showing that effect to the controller 53.

The controller 53 receives the detection signal S52, judges that the imaging unit 22-1 is positioned at (faces) the first opening 4b, and makes the automatic gain control circuit and image acquisition control circuit operate again to adjust the gain and adjust the image acquisition speed by the control signal CTL.

When rotating the camera unit 22 so that the transparent window 23f of the camera module 24 faces the direction of the object, if for example the rotating member 23 is rotated in the clockwise direction as seen from the right side, the end of the extension 26c wound around the outer circumference of the small diameter part 23b of the rotating member 23 with a clearance is pressed in the circumferential direction by the rotation of the small diameter part 23b, the extension 26c moves so as to narrow the clearance, and the force acting on the extension 26c due to the rotation of the rotating member 23 is absorbed inside the extension 26c.

When rotating the camera unit 22 so that the transparent window 23f of the camera module 24 faces the direction of the object, if for example the rotating member 23 is rotated in the counterclockwise direction as seen from the right side, the end of the extension 26c wound around the outer circumference of the small diameter part 23b of the rotating member 23 with a clearance is pulled in the circumferential direction by the rotation of the small diameter part 23b, the extension 26c moves so as to broaden the clearance, and the force acting on the extension 26c due to the rotation of the rotating member 23 is absorbed inside the extension 26c.

In this case, by the clearance of the extension 26c of the flexible circuit board 26 becoming narrower or broader, the force acting on the extensions 26a, 26b, and 26c of the flexible circuit board 26 from the camera unit 22 is absorbed and its transmittance avoided, so bending and torsion occurring at the extensions 26a, 26b, and 26c of the flexible circuit board 26 are avoided and damage or destruction of the extensions 26a, 26b, and 26c is prevented.

Further, by the winding of the extension 26c of the flexible circuit board 26 inside the casing 2a, extra space is eliminated when setting the flexible circuit board 26. The camera unit 22 provided with the flexible circuit board 26 is easily stored in the casing 2a.

As explained above, the present embodiment is provided with a controller 53 which, when receiving a detection signal S52 of the rotational position detector 52 and judging that the imaging unit 22-1 is positioned at (facing) the first opening 4a or 4b, makes the automatic gain control circuit and image acquisition control circuit operate to adjust the gain or adjust the image acquisition speed by the control signal CTL and, when judging that the imaging unit 22-1 is not positioned at (facing) the first opening 4a or 4b, stops the gain adjustment operation of the automatic gain control circuit and the image acquisition speed adjustment operation of the image acquisition control circuit, so it is possible to shorten the convergence time in the change of the AGC gain of the camera and the convergence time in the change of the image acquisition speed.

Further, since a static electricity ground line is formed passing through a first conductor 8 and second conductor 2b made of metal film from a drive system separate from the signal ground, the effect of static electricity on the system and camera unit can be effectively removed. Further, it is possible to arrange the vibrator motor 6 near the hinge section 3, so the vibrator motor is arranged near the center of the housing. Not only it is possible to transmit uniform vibration to the housing as a whole, but it is also possible to separate the logic system and the drive system, make the static electricity ground separate as well, facilitate design, increase resistance to noise etc., and stabilize operation.

Note that in the above embodiments, the electronic devices include, in addition to mobile phones, PDAs, digital cameras, laptop computers, and other mobile terminals provided with camera units. Further, in the above embodiments, not only light emitting units, but also for example microphones for inputting speech, compact liquid crystal display screens for enabling users to confirm the content of the operation of the mobile terminals, or other device for adding new functions to mobile terminals may be built in.

Summarizing the effects of the invention, it is possible to shorten the time required for image adjustment of a camera.

While the invention has been described with reference to specific embodiments chosen for purpose of illustration, it should be apparent that numerous modifications could be made thereto by those skilled in the art without departing from the basic concept and scope of the invention.

1. A camera device, comprising:
a housing at which at least one opening is formed,
a camera unit arranged rotatably inside said housing and arranged so that an imaging unit for capturing an image can be positioned at a said opening along with rotation,
an image processor for performing a predetermined adjustment operation on the captured image in accordance with a surrounding brightness,
a position detector for detecting a rotational position of said camera, and
a controller for making said image processor operate to perform a predetermined adjustment operation when the detection result of said position detector is that said imaging unit is positioned at said opening, and for making said image processor stop said predetermined adjustment operation when the detection result is that said imaging unit is not positioned at said opening.

2. A camera device as set forth in claim 1, wherein
said image processor includes an automatic gain control section operating in accordance with a control signal to adjust a gain for an image signal from said imaging unit in accordance with a surrounding brightness of said imaging unit and
said controller makes said automatic gain control section operate to adjust said gain by said control signal when the detection result of said position detector is that said imaging unit is positioned at said opening, and makes a gain adjustment operation of said automatic gain control section stop by said control signal when the detection result of said position detector is that said imaging unit is not positioned at said opening.

3. A camera device as set forth in claim 1, wherein
said image processor includes an image acquisition control section operating in accordance with a control signal to adjust an acquisition speed of an image in accordance with a surrounding brightness of said imaging unit and
said controller makes said image acquisition control section operate to adjust an acquisition speed of an image by said control signal when the detection result of said position detector is that said imaging unit is positioned at said opening, and makes an image acquisition speed adjustment operation of said image acquisition control section stop by said control signal when the detection result of said position detector is that said imaging unit is not positioned at said opening.

4. A camera device as set forth in claim 1, wherein
said image processor includes an automatic gain control section operating in accordance with a control signal to adjust a gain for an image signal from said imaging unit in said camera in accordance with a surrounding brightness of said imaging unit and an image acquisition control section operating in accordance with said control signal to adjust an acquisition speed of an image in accordance with a surrounding brightness of said imaging unit and
said controller makes said automatic gain control section and said image acquisition control section operate to adjust said gain and adjust an acquisition speed of an image by said control signal when the detection result of said position detector is that said imaging unit is positioned at said opening, and makes a gain adjustment operation and an image acquisition speed adjustment operation of said automatic gain control signal and said image acquisition control section stop by said control signal when the detection result of said position detector is that said imaging unit is not positioned at said opening.

5. An electronic device able to display an image captured by imaging unit on a display, comprising:
a housing at which at least one first opening is formed,
a camera unit including
casing which had the second opening formed so that the first opening may be faced to,
and imaging unit for capturing a picture through said second opening, while constituting rotating member supported to said housing so that said camera unit could position by rotation in the position in which said imaging unit can capture an image through said first opening,
a position detector for detecting a rotational position of said rotating member,
an image processor for performing a predetermined adjustment operation on the captured image unit in accordance with a surrounding brightness, and
a controller for making said image processor operate to perform said predetermined adjustment operation when the detection result of said position detector is that said imaging unit is positioned at said first opening and for making said predetermined adjustment operation of said image processor stop when the detection result of said position detector is that said imaging unit is not positioned at said first opening.

6. An electronic device as set forth in claim 5, wherein
said image processor includes an automatic gain control section operating in accordance with a control signal to adjust a gain for an image signal from an imaging unit in said camera in accordance with a surrounding brightness of said imaging unit and
said controller makes said automatic gain control section operate to adjust said gain by said control signal when the detection result of said position detector is that said imaging unit is positioned at said first opening and makes a gain adjustment operation of said automatic gain control section stop by said control signal when the detection result of said position detector is that said imaging unit is not positioned at said first opening.

7. An electronic device as set forth in claim 5, wherein
said image processor includes an image acquisition control section operating in accordance with a control signal and adjusting an acquisition speed of an image in accordance with a surrounding brightness of said imaging unit and
said controller makes said image acquisition control section operate to adjust an acquisition speed of an image by said control signal when the detection result of said position detector is that said imaging unit is positioned at said first opening and makes an image acquisition speed adjustment operation of said image acquisition control section stop by said control signal when the detection result of said position detector is that said imaging unit is not positioned at said first opening.

8. An electronic device as set forth in claim 5, wherein
said image processor includes an automatic gain control section operating in accordance with a control signal to adjust a gain for an image signal from said imaging unit in said camera in accordance with a surrounding brightness of said imaging unit and an image acquisition control section operating in accordance with said control signal to adjust an acquisition speed of an image in accordance with a surrounding brightness of said imaging unit and
said controller makes said automatic gain control section and said image acquisition control section operate to adjust said gain and adjust an acquisition speed of an image by said control signal when the detection result of said position detector is that said imaging unit is positioned at said first opening and makes a gain adjustment operation and an image acquisition speed adjustment operation of said automatic gain control signal and said image acquisition control section stop by said control signal when the detection result of said position detector is that said imaging unit is not positioned at a said first opening.

9. An image processing method for a camera device comprising a housing at which at least one opening is formed and a camera unit arranged rotatably inside said housing and arranged so that an imaging unit for capturing an image can be positioned at a said opening along with rotation,
said image processing method comprising:
an image processing step for performing a predetermined adjustment operation on the captured image in accordance with a surrounding brightness,
a position detection step for detecting a rotational position of said camera, and
a control step for activating said image processing step when said imaging unit is positioned at a said opening and for deactivating said image processing step operate when said imaging unit is not positioned at a said opening.

10. An image processing method for a camera device as set forth in claim 9, wherein
said image processing step includes an automatic gain control step for adjusting a gain for an image signal from said imaging unit in accordance with a surrounding brightness of said imaging unit and
said control step activates said automatic gain control step when said imaging unit is positioned at a said opening and deactivates said automatic gain control step when said imaging unit is not positioned at a said opening.

11. An image processing method for a camera device as set forth in claim 9, wherein
said image processing step includes an image acquisition control step for adjusting an acquisition speed of an image in accordance with a surrounding brightness of said imaging unit and
said control step activates said image acquisition control step when said imaging unit is positioned at said opening and deactivates said image acquisition control step when said imaging unit is not positioned at a said opening.
